(19) United States
(12) Patent Application Publication
(10) Pub. No.: US 2009/0086106 A1
(43) Pub. Date: Apr. 2, 2009

(54) VIDEO SIGNAL PROCESSING CIRCUIT AND ELECTRIC DEVICE IN WHICH THE SAME IS MOUNTED

(75) Inventor: Kinya Takama, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 11/994,083

(22) PCT Filed: Jun. 27, 2006
(86) PCT No.: PCT/JP2006/312805

§ 371 Date: Dec. 27, 2007

(30) Foreign Application Priority Data
Jun. 29, 2005 (JP) 2005-189353

(51) Int. Cl. H04N 5/14

(52) U.S. Cl. 348/707; 348/E05.068

(57) ABSTRACT

The video amplifying circuit amplifies the video signal with a given gain. The charge pump circuit generates the other voltages from a given fixed voltage in order to provide the video amplifying circuit with a plurality of mutually different power supply voltages. The oscillating circuit provides the charge pump circuit with a clock frequency. Noise caused by the clock frequency of the charge pump circuit is flown into the video amplifying circuit. The oscillating circuit sets the clock frequency so as to visually reduce the quality deterioration caused by image noises that occur in an image generated from the video signal processed by the video amplifying circuit.

### BACKGROUND OF THE INVENTION

1. Field of the Invention

The present invention relates to a video signal processing circuit which uses voltages that are provided from a DC-DC converter or the like, and relates to an electronic device in which the same is mounted.

2. Description of the Related Art

In an electronic circuit dealing with video signal (hereinafter referred to as “video signal processing circuit”), a plurality of different voltages used in the video signal processing circuit are sometimes required, not one type of power supply voltage. In such cases, a measure can be considered to provide a plurality of power supply voltages from an outside power supply circuit. Instead of providing a plurality of power supply voltages from outside, there is also a measure to provide one type of power supply voltage and to obtain a plurality of voltages using a charge pump circuit functioning to convert one type of the power supply voltage into different voltages.

It generally follows from the operating principle of a charge pump circuit that an output voltage is not ideal due to a noise occurring in a rising edge or a trailing edge of the clock and the ripple components of the clock frequency remaining in the output voltage. For example, Patent document 1 discloses an uneven display caused by the ripple occurring in the drive voltage.

Patent Document 1: JP Patent Application Laid-open No. 2001-92402

### SUMMARY OF THE INVENTION

When a voltage generated in such a charge pump circuit is used in a video signal processing circuit, a circuit element of the video signal processing circuit can be affected because the video signal processing circuit operates after being provided with the voltage in which noises are superimposed. In particular, when a video signal processing circuit and a charge pump circuit are both mounted in the same IC chip of a semiconductor IC or the like, it becomes a more serious problem because a clock frequency of the charge pump circuit interferes directly in the video signal processing circuit. In images played back in such a video signal processing circuit, an image noise such as a stripe line occurs due to the noise component from the charge pump circuit, which makes the image quality lower.

In view of these situations, the present invention has been made, and a general purpose of the present invention is to provide a video signal processing circuit that can reduce the influence of the image quality deterioration in a circuit configuration provided with voltage from a DC-DC converter or the like, and to provide an electronic device in which the video processing circuit is mounted.

The video signal processing circuit according to an embodiment of the invention includes: a video signal processing unit which subjects a video signal to a given process; a circuit which generates the other voltages from a given fixed voltage to provide the video signal processing unit with a plurality of mutually different power supply voltages; and a clock generating circuit which provides the circuit which generates the other voltages with a clock frequency, wherein the clock frequency is selected so that the clock generating circuit visually reduces quality deterioration caused by an image noise occurring in an image that is generated from the video signal processed by the video signal processing unit into which a noise caused by the clock frequency of the circuit which generates the other voltages is introduced. “A given fixed voltage” may be a power supply voltage. “A clock generating circuit” may be an oscillating circuit or a circuit generating a new clock by converting a given clock.

According to this embodiment, by adjusting a clock frequency of a DC-DC converter or the like, it is possible to visually adjust the influence that an image noise caused by a noise occurring with switching actions of a DC-DC converter or the like, exerts on the image quality.

The clock generating circuit may have the clock frequency set so that a line made from a collection of image noises occurring in an image runs obliquely. Further, the clock generating circuit may have the clock frequency set so that the line moves at a given speed or higher. Furthermore, the clock generating circuit may have the clock frequency set so that a plurality of lines occur. The clock frequency may be set within the range of 90 kHz to 230 kHz. According to this embodiment, an image noise can be adjusted to one that is difficult to notice for the human eye.

The clock generating circuit may have the clock frequency set so that the clock frequency and the frequency of the horizontal synchronizing signal of the video signal satisfy a given relationship. The clock generating circuit may have the clock frequency set so that the clock frequency is not an integral multiple or an approximate integral multiple of the frequency of the horizontal synchronizing signal of the video signal. As the clock frequency approaches an integral multiple of the horizontal synchronizing signal of the video signal, an occurring image noise becomes a motionless vertical line in shape. According to this embodiment, such an image noise can be prevented from occurring.

The video signal processing unit may include an operational amplifier for amplifying input signal with a given gain. The operational amplifier may operate with a plurality of power supply voltages and may receive provision of at least one of the power supply voltages from the circuit which generates the other voltages. The circuit which generates the other voltages may be a DC-DC converter, which may generate the negative voltage by stepping down a given fixed voltage, and the operational amplifier may operate with the given fixed voltage being provided from a positive power supply terminal and with the negative voltage being provided from a negative power supply terminal. By using the operational amplifier of the positive and negative power supplies, it is possible to adjust the output voltage level of the operational amplifier and to simplify the circuit element in a subsequent stage.

At least, the video signal processing unit and the circuit which generates the other voltages may be integrated on the same semiconductor substrate. The clock generating circuit may also be integrated on the same substrate.

Another embodiment of the present invention is an electric device. This electric device includes a video signal processing circuit and a battery providing the video signal processing circuit with a given fixed voltage. According to this embodiment, it is possible to configure a video signal processing circuit having a plurality of power supplies with a small-scale circuit, and also possible to reduce the influence of the image quality deterioration caused by the use of a DC-DC converter.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an example of images displayed on the display in accordance with the horizontal synchronizing signal;

FIG. 2 shows a configuration of the video signal processing circuit and the display unit according to the embodiment 1 of the present invention;

FIG. 3 shows the characteristics between the oscillating frequency and the ripple rejection ratio;

FIG. 4 shows a configuration example of the oscillating circuit;

FIG. 5 shows a pathway on which the noise occurring in the charge pump circuit flows into the previous circuit;

FIG. 6 shows a portable apparatus and a display device in which a video signal processing circuit is mounted.

### DETAILED DESCRIPTION OF THE INVENTION

The present invention will be explained below with reference to the accompanying drawings. The same or equivalent component parts, members and processes shown in each drawing shall be denoted by the same reference symbols, and duplicated explanations are omitted appropriately. In addition, embodiments do not limit the invention, only describe exemplifications, and not all of the features and combinations thereof described in the embodiments are essential to the present invention.

At first as premise, a video signal that is input into a video signal processing circuit according to the embodiment of the invention will be explained. The video signal includes the horizontal synchronizing signal besides image information, and images are played back on the display of the TV screen or the like, based on the horizontal synchronizing signal. In the horizontal synchronizing signal, the frequency of 15.734 kHZ is adopted for NTSC method, and the frequency of 15.625 kHz for PAL method.

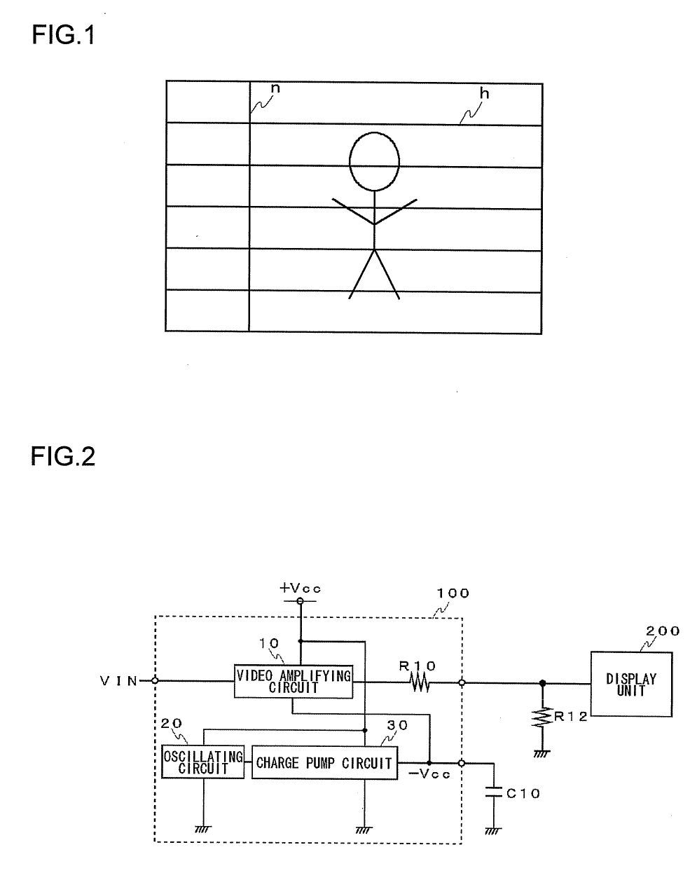

FIG. 1 shows an example of images displayed on the display according to the horizontal synchronizing signal. According to the horizontal synchronizing signal, an image is formed as the electronic beam scans from top left to bottom right of the screen. As illustrated with the scanning line h in FIG. 1, multiple scans from left periphery to right periphery of the screen form an image. The horizontal synchronizing signal specifies the frequency of one scan from left periphery to right periphery of the screen.

Here, if the frequency of the noise introduced into from the charge pump circuit described later is the same as that of the horizontal synchronizing signal, a noise of vertical line n appears on the screen. This occurs because if both frequencies are the same, the noises n occur in the same position for each scanning line h, and each noise n is in a vertical line on the screen. In addition, the occurrence of the noise in the same position makes the line seem motionless. If the frequency of the noise introduced into from the above charge pump circuit is twice that of the horizontal synchronizing signal, two motionless vertical lines n occur based on the same principle. Further, the same phenomena will continue as the frequency of the noise increases, and when the ratio between the frequency of the noise and that of the horizontal synchronizing signal is an integral ratio, as many vertical lines n as the ratio occur.

On the other hand, as the frequency of the noise introduced into from the charge pump circuit is getting higher than that of the horizontal synchronizing signal, the vertical lines run obliquely then laterally, which makes the noise difficult to notice for the human eye. As described above, the vertical lines n are very noticeable because they are motionless on the screen. Conversely, when the relationship between the both frequencies is set so as not to make the vertical lines n occur, it is possible to reduce the influence of the image quality deterioration by the noise introduced into from the charge pump circuit. Using this knowledge, the video signal processing circuit of which the clock frequency is set so that the clock frequency is not an integral multiple of the frequency of the horizontal synchronizing signal, will be explained below.

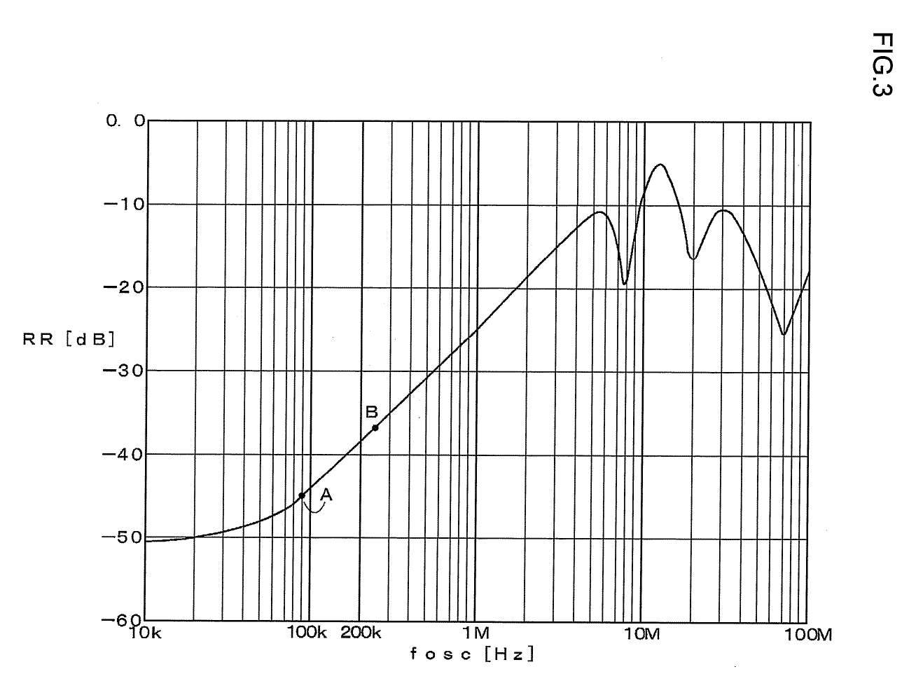

FIG. 2 shows the configuration of the video signal processing circuit 100 and the display unit 200 according to the embodiment 1 of the invention. The video signal processing circuit 100 according to the embodiment amplifies the input video signal and provides the display unit 200 with the signal through the 75 Ω driver. The video signal processing circuit 100 includes the video amplifying circuit 10, the oscillating circuit 20 and the charge pump circuit 30. In addition, an output terminal of the video amplifying circuit 10 is connected to an input terminal of the display unit 200 through a first resistance R10. A second resistant R12 is connected between a connection point of the first resistance R10 and the input terminal of the display unit 200, and the ground. The first resistance R10 and the second resistance R12 function as a 75 Ω driver.

The video amplifying circuit 10, the oscillating circuit 20 and the charge pump circuit 30 are provided with the power supply voltage Vcc. The video amplifying circuit 10 is connected to a first capacitance C10 to be provided with the negative power supply. The first capacitance C10 maintains the output voltage of the charge pump circuit 30. FIG. 2 shows an example in which the video amplifying circuit 10, the oscillating circuit 20, the charge pump circuit 30, and the first resistance R10 are implemented on an IC chip. This video signal processing circuit 100 is not limited to an IC chip configuration, and if they are implemented on an IC chip, a designer can have an arbitrary circuit element implemented on an IC chip.

The video amplifying circuit 10 is configured using an operational amplifier or the like, and amplifies the input video signal with a given gain. According to this embodiment, the operational amplifier uses two power supplies, that is, the positive and the negative power supplies, not a single power supply. Employing the operational amplifier using two power supplies can make it possible to set the direct current component to 0V level, and therefore, connection of a greater capacitance to the output of the operational amplifier is not required, which contributes to reduction in the size of the entire circuit.

As described above, the charge pump circuit 30 generates the negative voltage using the power supply voltage Vcc to provide the video amplifying circuit 10 with the negative voltage. That is, the charge pump circuit 30 includes a capacitance and a switch functioning to change the pathways of capacitance between a first pathway of the power supply voltage Vcc through the ground and a second pathway of power supply voltage Vcc through the capacitance serving as maintaining the output voltage, as a basic configuration. The charge pump circuit 30 reverses the power supply voltage Vcc in such a process. In addition, the charge pump circuit 30 is an example of a DC-DC converter, and it may be a switching regulator or the like.

The oscillating circuit 20 forms a clock functioning to carry out on/off control of the switch in the charge pump circuit 30. In this embodiment, the frequency of the clock is adjusted so as not to be an integral multiple of the frequency of horizontal synchronizing signal of the above video signal. With respect to the clock frequency of the charge pump circuit 30, from the viewpoint of the image quality generated from the video signal, making the clock frequency of the charge pump circuit 30 lower can curb the noise occurring in images. Further, as the frequency is higher, the noise is more unnoticeable for the human eye because the noise in images runs faster. A sensitivity evaluation may indicate that the more stripe lines there are, the less noticeable they are. Opposing to this, the appropriate frequency range of the charge pump circuit 30 exists in accordance with its specification, in order to exert the performance of the charge pump circuit 30 sufficiently. In view of these aspects, for example, the frequency range of the clock frequency of the charge pump circuit 30 is set within about 90 kHz to about 230 kHz, and also set so as not to be an integral multiple of the horizontal synchronizing signal.

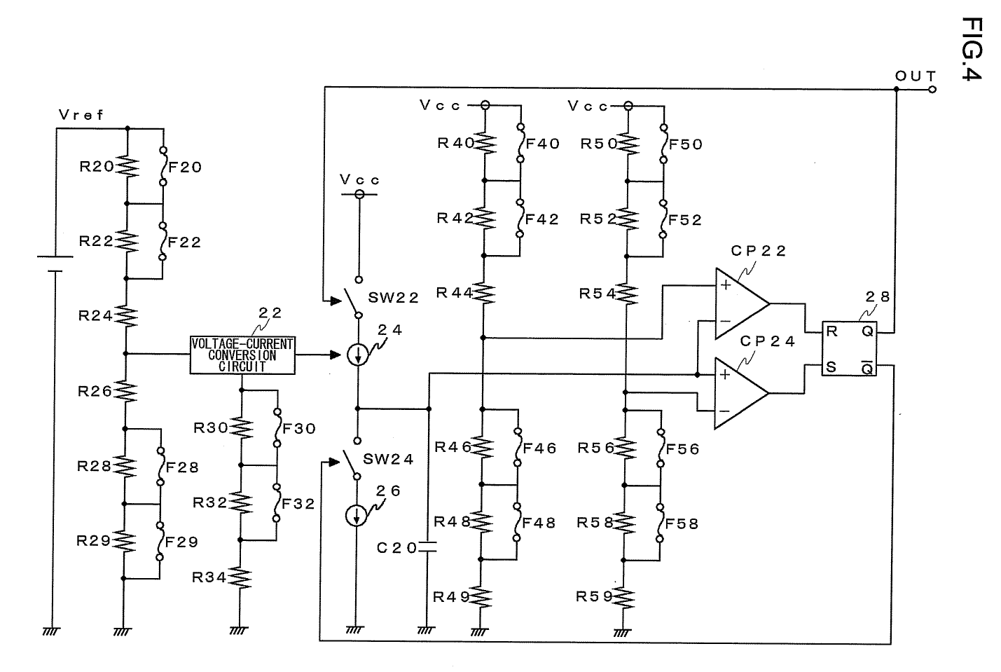

Making the oscillating frequency of the oscillating circuit 20 that specifies the clock frequency of the charge pump circuit 30 higher, decreases the ripple rejection ratio of the video amplifying circuit 10. FIG. 3 shows the characteristics between the oscillating frequency and the ripple rejection ratio. While the horizontal axis of the FIG. 3 shows the oscillating frequency fosc in logarithmic scale, the vertical axis shows the ripple rejection ratio RR. In FIG. 3, as dot A shows, when the oscillating frequency fosc is 90 kHz, the ripple rejection ratio RR is −45 dB, while as dot B shows, when the oscillating frequency fosc is 230 kHz, the ripple rejection ratio RR is −37 dB. The difference 8 dB corresponds to about 2.5 times. At the time, the oscillating frequency fosc is also 230/90=2.5 times. That is, the ripple rejection ratio RR decreases proportionately to the oscillating frequency fosc.

On the other hand, since the ripple voltage occurring in the power supply decreases proportionately to the oscillating frequency fosc, the decrease of the ripple voltage is offset by the increase of the ripple rejection ratio and then, the ripple voltage level appearing in the output of the video amplifying circuit 10 is unrelated to the oscillating frequency fosc. The effect of lowering the oscillating frequency fosc levels out because the ripple rejection ratio is no longer increased beyond a certain limit.

On the other hand, to control interference fringes occurring on the screen, precise control at the interval of an integral multiple of about 15 kHz of the horizontal synchronizing signal, that is, at the interval of about 15 kHz, is required. Making the oscillating frequency fosc of the oscillating circuit 20 higher, decreases the stability of the oscillating frequency fosc since the ratio between 15 kHz and the oscillating frequency fosc is severe. In view of these situations, this embodiment sets the clock frequency of the charge pump circuit 30 to the range of about 90 kHz to about 230 kHz.

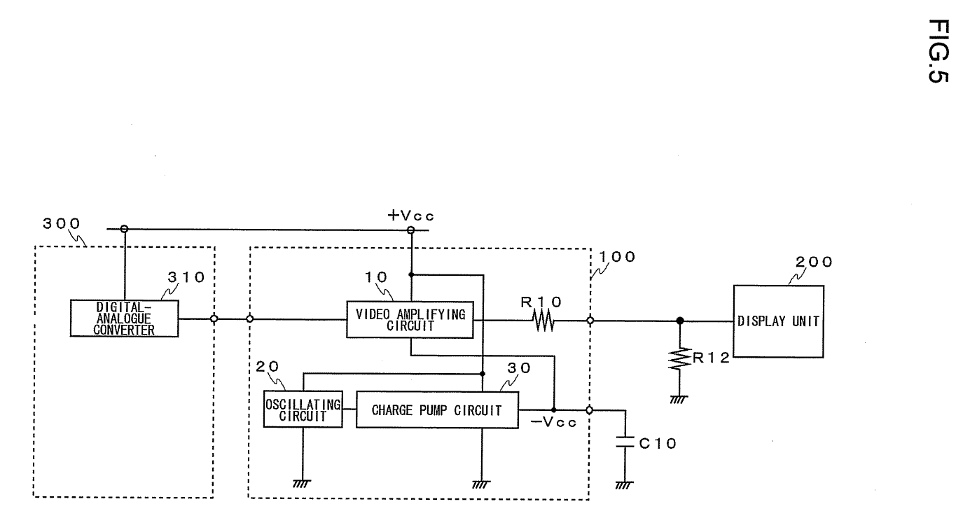

The configuration of the oscillating circuit 20 to adjust the clock frequency of the charge pump circuit 30 will be explained below. FIG. 4 shows a configuration example of the oscillating circuit 20. This oscillating circuit 20 includes a pair of a first comparator CP22 and a second comparator CP24, and a flip-flop 28. The first comparator CP22 and the second comparator CP24 function as a window comparator. A serial circuit of a first constant current source 24 and a second constant current source 26 is provided between the power supply voltage Vcc and the ground. A second capacitance 20 is provided in parallel with the connection point of the first constant current source 24 and the second constant current source 26. The second capacitance 20 makes the voltage at the connection point triangular-wave-shaped. The output voltage of the second capacitance 20 is applied to an inverting input terminal of the first comparator CP22 and to a non-inverting input terminal of the second comparator CP24. A first and a second reference voltages which are generated by dividing the power supply voltage Vcc with each resistance string are applied to a non-inverting input terminal of the first comparator CP22 and to the second comparator CP24, respectively.

A first switch SW22 is provided between the power supply voltage Vcc and the first constant current source 24, and a second switch SW24 is provided between the second constant current source 26 and a connection point of the first constant current source 24 and the second constant current source 26. The first switch SW22 is subject to on/off control by the output signal of the flip-flop 28, and the second switch SW24 is subject to on/off control by its inverting signal. In addition, a voltage-current conversion circuit 22 is provided for providing the above first constant current source 24 with current. The voltage-current conversion circuit 22 generates the current provided to the first constant current source 24, based on the voltage generated from a third reference voltage Vref.

The first comparator CP22 and the second comparator CP24 output a high level signal or a low level signal after comparing the reference voltages generated by each resistant string with the above triangular-wave-shaped input voltage. The output signal of the first comparator CP22 is input to the reset terminal of the flip-flop 28, and the output signal of the second comparator CP24 is input to the set terminal of the flip-flop 28. In the first comparator CP22 and the second comparator CP24, since the input terminals are opposite to each other in respect of their connections, the phases of the output signals are opposite to each other. The flip-flop 28 latches signals input from the first comparator CP22 and the second comparator CP24 for a given period, and outputs them to meet a given timing, respectively. FIG. 4 shows a flip-flop 28 of a RS latch type. The output signal of the flip-flop 28 is a square-wave-shaped signal, and is the clock frequency providing to the charge pump circuit 30. In addition, as described above, the opposite-phase output signal of the output signal is the signal to carry out on/off control for the second switch SW24.

In a configuration like the oscillating circuit 20, a designer adjusts a resistance value or a capacitance value that determines the frequency of the output signal of the oscillating circuit 20 using laser trimming or diode zapping or the like. Therefore, the clock frequency used in the charge pump circuit 30 can be set to the desired value.

For example, as shown in FIG. 4, the reference voltage provided to the voltage-current conversion circuit 22, the reference current provided to the first constant current source 24, and the first and the second reference voltages provided to the first comparator CP22 and the second comparator CP24 or the like can be adjusted by trimming. In order to adjust the voltage provided to the voltage-current conversion circuit 22, six resistances of the third resistance R20 through the eighth resistance R29 are connected in series between the third reference voltage Vref and the ground. The first fuse F20, the second fuse F22, the third fuse F28, and fourth fuse F29 are connected in parallel with the third resistance R20, the fourth resistance R22, the seventh resistance R28, and the eighth resistance R29, respectively. The reference voltage provided to the voltage-current conversion circuit 22 is obtained from the connection point between the fifth resistance R24 and the sixth resistance R26. A designer can set the resistant string in accordance with the predetermined voltage division ratio by melting down one or more fuses of the above a plurality of the fuses with laser.

Next, in case the voltage-current conversion circuit 22 is configured with an operational amplifier, the output current can be adjusted by adjusting the value of the feedback resistance or the value of the resistance for generating its reference voltage. Like this, adjustment of a resistance value for adjusting the ratio between the input voltage and the output current can be achieved, using the resistance strings including the ninth resistance R30, the tenth resistance R32 and the eleventh resistance R3; and the third fuse F30 and the fourth fuse F32 that are connected in parallel with the ninth resistance R30 and the tenth resistance R32, respectively.

In addition, six resistances from the twelfth resistance R40 through the seventeenth resistance R49 are connected in series between the power supply voltage Vcc and the ground. The seventh fuse F40, the eighth fuse F42, the ninth fuse F46, and the tenth fuse F48 are connected in parallel with the twelfth resistance R40, the thirteenth resistance R42, the fifteenth resistance R46, and the sixteenth resistance R48, respectively. The reference voltage provided to the first comparator CP22 is obtained from the connection point between the fourteenth resistance R44 and the fifteenth resistance R46. The second comparator CP24 may be the same circuit configuration, using the eighteenth resistance R50, the nineteenth resistance R52, the twentieth resistance R54, the twenty-first resistance R56, the twenty-second resistance R58, the twenty-third resistance R59, the eleventh fuse F50, the twelfth fuse F52, the thirteenth fuse F56, and the fourteenth fuse F58.

Further, the capacitance value of the second capacitance may be adjusted. A designer may employ one way for adjustment, or two or more ways cumulatively. Furthermore, a diode may be employed in place of a fuse. In the case, the diode may be short-circuited by causing a current beyond the break down voltage to flow in the diode.

As described above, according to the embodiment, when providing the video amplifying circuit amplifying the video signal with the power supply from the charge pump circuit, the influence of the image quality deterioration played back from the above video signal may be reduced by setting the clock frequency of the charge pump circuit not to make a certain relationship between the noise frequency introduced into from the charge pump circuit, and the frequency of the horizontal synchronizing signal of the above video signal.

More specifically, at first, the influence of the image quality deterioration by a noise introduced into the negative power supply terminal of the operational amplifier included in the above video amplifying circuit, from the charge pump circuit may be reduced. In addition, current changes corresponding to switching actions occur in the power supply terminal of the charge pump circuit. As shown in FIG. 2, when the video amplifying circuit 10 and the charge pump circuit 30 are provided with the power supply voltage Vcc from the same power supply line, the noises caused by the current changes can flow into the positive power supply terminal of the operational amplifier included in the video amplifying circuit 10. To prevent this occurring, there is a way providing the power supply line connecting the video amplifying circuit 10 to the charge pump circuit 30, with a ripple filter including a capacitance and a coil or the like, however, it causes increase of the circuit area. With respect to this, according to the embodiment, the influence of the image quality deterioration caused by the noise introduced into through such a pathway may be reduced. Therefore, an option not employing a filter such as a ripple filter may be adopted, and in the case, the circuit area may be reduced.

Further, it is possible that the noise occurring in the charge pump circuit is introduced into the preceding circuit to cause the noise to be mixed in the video signal in the preceding circuit. FIG. 5 illustrates the pathway on which the noise occurring in the charge pump circuit flows into the preceding circuit. Another circuit 300 implemented on an IC chip is provided to precede the video signal circuit 100 implemented on an IC chip that is illustrated in FIG. 2. For example, the preceding circuit 300 may include a digital-analogue converter 310 and carry out the process for converting the video signal of digital data to the video signal of analogue data. As shown in FIG. 5, when a plurality of circuits implemented on IC chips 300 and 400 are provided with the power supply voltage Vcc from the same power supply line, the noise occurring in the charge pump circuit 30 may be introduced into the digital-analogue converter 310 via the power supply line. According to the embodiment, the influence of the image quality deterioration caused by the noise introduced into on such a pathway, may be reduced.

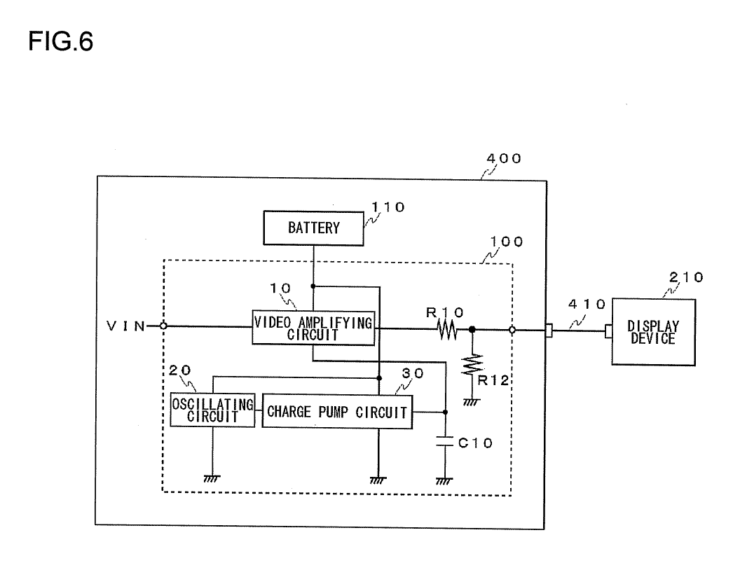

Next, an electronic device 400 in which the video signal processing circuit 100 is mounted in accordance with the above embodiment, will be explained. FIG. 6 shows the electronic device 400 in which the video processing circuit 100 is mounted, and the display unit 210. A portable apparatus such as a mobile phone or a digital camera could fall under the category of the electronic device 400. The electronic device 400 includes the video signal processing circuit 100 and a battery 110 providing the video signal processing circuit with the power supply voltage. The electronic device 400 can be connected to a display unit 210 such as a TV set through a cable 410, and is able to display the video signal on the display unit. For example, pictures captured with a camera or the like mounted in the electronic device 400, but not shown in Figs., can be displayed on the display unit 210.

As described above, the present invention is an effective technology when it is difficult to be provided with a plurality of power supply voltages from outside. It can be said that a portable apparatus is just in such a situation. The video signal processing circuit 100 according to the above embodiment can reduce the influence of the quality deterioration of the image generated from the video signal, without decreasing the noise occurring from the charge pump circuit by using a ripple filter and so on, which leads to consist reduction in the size of a circuit with measurement for image noise.

The present invention has been described based on embodiments. It is understood to a person skilled in the art that the embodiments are only exemplary, and various modifications are possible in combinations of each configuration element and each processing process, and those modifications are also within the scope of the present invention.

In the above embodiments, an example in which the clock frequency of the charge pump circuit 30 is provided from an oscillating circuit 20 in the same IC chip has been described. With respect to this, if a desired clock frequency can be obtained from outside, the clock may be the clock frequency of the charge pump circuit 30. In the case, reduction in the size of the IC chip commensurate with the absence of the oscillating circuit 20 is achieved.

The present invention has been described according to the embodiments, but it goes without saying that the embodiments only show the principles and applications of the present invention, and that many examples of variation or modifications of arrangement are possible in the embodiments without departing from the spirit of the present invention.

1. A video signal processing circuit comprising:
a video signal processing unit which subjects a video signal to a given process;
a circuit which generates the other voltages from a given fixed voltage to provide the video signal processing unit with a plurality of mutually different power supply voltages; and
a clock generating circuit which provides the circuit which generates the other voltages with a clock frequency, wherein the clock frequency is selected so that the clock generating circuit visually reduces quality deterioration caused by image noise occurring in images that are generated from the video signal processed by the video signal processing circuit into which a noise caused by the clock frequency of the circuit which generates the other voltages is introduced.

2. The video signal processing circuit according to claim 1, wherein the clock generating circuit has the clock frequency set so that a line made from a collection of image noises occurring in the images runs obliquely.

3. The video signal processing circuit according to claim 2, wherein the clock generating circuit has the clock frequency set so that the line moves at a given speed or higher.

4. The video signal processing circuit according to claim 2, wherein the clock generating circuit has the clock frequency set so that a plurality of lines occur.

5. The video signal processing circuit according to claim 1, wherein the clock generating circuit has the clock frequency set so that the clock frequency and the frequency of the horizontal synchronizing signal of the video signal satisfy a given relationship.

6. The video signal processing circuit according to claim 5, wherein the clock generating circuit has the clock frequency set so that the clock frequency is not an integral multiple of the frequency of the horizontal synchronizing signal of the video signal.

7. The video signal processing circuit according to claim 6, wherein the clock generating circuit includes a circuit for adjusting the clock frequency.

8. A video signal processing circuit comprising:
a video signal processing unit which subjects a video signal to a given process;
a circuit which generates the other voltages from a given fixed voltage to provide the video signal processing circuit with a plurality of mutually different power supply voltages; and
a clock generating circuit which provides the circuit which generates the other voltages with a clock frequency, wherein the clock generating circuit has the clock frequency set so that the clock frequency is not an integral multiple of the frequency of the horizontal synchronizing signal of the video signal.

9. The video signal processing circuit according to claim 8, wherein the clock generating circuit includes a circuit for adjusting the clock frequency.

10. The video signal processing circuit according to claim 1, wherein the clock generating circuit includes a circuit for adjusting the clock frequency so that the clock frequency is not an integral multiple of the frequency of the horizontal synchronizing signal of the video signal.

11. The video signal processing circuit according to claim 10, wherein the clock generating circuit adjusts the clock frequency by trimming a resistance value or a capacitance value that determine the clock frequency.

12. The video signal processing circuit according to claim 1, wherein the video signal processing unit includes an operational amplifier for amplifying an input video signal with a given gain, and the operational amplifier operates with positive and negative power supply voltages, and the operational amplifier is provided with at least one of the power supply voltages from the circuit which generates the other voltages.

13. The video signal processing circuit according to claim 12, wherein the circuit which generates the other voltages is a DC-DC converter and the DC-DC converter generates the negative voltage by stepping down the given fixed voltage, and the operational amplifier operates with the given fixed voltage being provided from a positive power supply terminal and with the negative voltage being provided from a negative power supply terminal.

14. The video signal processing circuit according to claim 1, wherein the clock generating circuit comprises:
a first comparator and a second comparator serving as a window comparator;
a flip-flop that latches signals input from the first comparator and the second comparator for a given period, and outputs them to meet given timing;
a first constant current source and a second constant current source provided in series between a power supply voltage and the ground;
a capacitance that is provided in parallel with the connection point between the first constant current source and the second constant current source, and that makes the voltage of the connection point triangular-wave shaped to apply it to the first comparator and the second comparator;
a first switch provided between the power supply voltage and the first constant current source;
a second switch provided between the connection point and the second constant current source; and
a voltage-current conversion circuit for providing the first constant current source with a current, wherein the first switch is subject to on/off control by the output signal of the flip-flop, whereas the second switch is subject to on/off control by the inverted version of the output signal.

15. The video signal processing circuit according to claim 14, wherein a reference voltage provided to the voltage-current conversion circuit is adjusted by trimming a resistance string provided between a given reference voltage and the ground.

16. The video signal processing circuit according to claim 14, wherein an output current of the voltage-current conversion circuit is adjusted by trimming a resistance string for adjusting the ratio between the input voltage and the output current of the voltage-current conversion circuit.

17. The video signal processing circuit according to claim 14, wherein a reference voltage provided to the first comparator and the second comparator is adjusted by trimming the resistance string provided between the power supply voltage and the ground.

18. The video signal processing circuit according to claim 1, wherein at least the video signal processing unit and the circuit which generates the other voltages are integrated on the same semiconductor substrate.

19. An electronic device comprising:
a video signal processing circuit according to claim 1 4; and
a battery providing the video signal processing circuit with the given fixed voltage.
